(19) United States
(12) Patent Application Publication
(10) Pub. No.: US 2026/0021568 A1
(43) Pub. Date: Jan. 22, 2026

(54) WORKBENCH

(71) Applicant: HANGZHOU GREAT STAR INDUSTRIAL CO., LTD., Hangzhou (CN)

(72) Inventor: Jingjian LI, Hangzhou (CN)

(21) Appl. No.: 19/339,398

(22) Filed: Sep. 25, 2025

Related U.S. Application Data
(63) Continuation of application No. PCT/CN2024/074625, filed on Jan. 30, 2024.

(30) Foreign Application Priority Data
Apr. 19, 2023 (CN) 202310445872.8

(51) Int. Cl. B25H 1/04; A47B 3/091; B25H 1/16

(52) U.S. Cl. CPC B25H 1/04; A47B 3/0911; B25H 1/16

(57) ABSTRACT

A workbench is provided. The workbench includes a bearing platform, two supporting structures, a control member and a connecting assembly. The bearing platform includes a bearing surface and a back surface away from each other. The two supporting structures are rotatably mounted on the back surface, respectively. The control member is movably connected to the bearing platform. The connecting assembly is configured for connecting the control member to the two supporting structures. The control member is capable of driving the two supporting structures to rotate via the connecting assembly under the action of an external force. When the workbench is in the folded state, both of the two supporting structures are adjacent to the back surface. When the workbench is in the support state, the two supporting structures are capable of supporting the bearing platform.

### CROSS-REFERENCE TO RELATED APPLICATION

This application is a continuation patent application No. PCT/CN2024/074625, filed on Jan. 30, 2024, which itself claims priority to Chinese patent application No. 202310445872.8, filed on Apr. 19, 2023, and titled “WORKBENCH”. The content of the above identified applications is hereby incorporated herein in its entirety by reference.

### TECHNICAL FIELD

The present disclosure relates to the field of workbench, and in particular, to a workbench.

### BACKGROUND

When a workbench in the related art is used, a supporting structure at one side should be rotated to a preset position, and then a supporting structure at the other side should be rotated to a preset place, so that the workbench is switched to a supporting state that is convenient for use. When the workbench is switched from the support state to a folded state, the supporting structures at both sides of the workbench should be rotated to fold, respectively. This process is complex, and users have a poor experience.

### SUMMARY

In view of above, a workbench is provided.

In the present disclosure, the workbench includes a bearing platform, two supporting structures, a control member and a connecting assembly. The bearing platform includes a bearing surface and a back surface away from each other. The two supporting structures are rotatably mounted on the back surface, respectively. The control member is connected to the bearing platform and capable of moving relative to the bearing platform. The connecting assembly is configured for connecting the control member to the two supporting structures. The control member is capable of driving the two supporting structures to rotate via the connecting assembly under the action of an external force, such that the workbench is capable of switching between a folded state or a support state. When the workbench is in the folded state, both of the two supporting structures are adjacent to the back surface. When the workbench is in the support state, the two supporting structures are capable of supporting the bearing platform.

Details of one or more embodiments of the present disclosure are presented in the attached drawings and descriptions below. And other features, purposes and advantages of the present disclosure will become apparent from the description, drawings and claims.

### BRIEF DESCRIPTION OF THE DRAWINGS

For a better description and illustration of embodiments and/or examples of those disclosures disclosed herein, reference may be made to one or more attached drawings. Additional details or examples used to describe the drawings should not be considered as limiting the scope of any of the disclosed disclosures, currently described embodiments and/or examples, and currently understood best modes of these disclosures.

FIG. 1 is a structural schematic diagram of a workbench in a support state in an embodiment of the present disclosure.

FIG. 2 is a structural schematic diagram of the workbench in FIG. 1 from a first angle of view.

FIG. 3 is an enlarged schematic diagram of portion X in FIG. 2.

FIG. 3a is a structural schematic diagram of a driving block in FIG. 3.

FIG. 4 is a structural schematic diagram of the workbench in FIG. 1 from a second angle of view.

FIG. 5 is a sectional view of the workbench along A-A line in FIG. 4.

FIG. 6 is a sectional view of the workbench along B-B line in FIG. 4.

FIG. 7 is a structural schematic diagram of a bearing platform of the workbench in FIG. 1

FIG. 8 is a structural schematic diagram of the workbench, in which the workbench is in the process of being switched from a support state to a folded state in FIG. 1.

FIG. 9 is a structural schematic diagram of the workbench in FIG. 1 in the folded state.

FIG. 10 is an enlarged schematic diagram of portion Y in FIG. 9.

FIG. 11 is a schematic diagram of the workbench in FIG. 10 from another angle of view.

FIG. 12 is a sectional schematic view of the workbench along C-C line in FIG. 11.

FIG. 13 is a structural schematic diagram of a part of the workbench in FIG. 11.

FIG. 14 is an enlarged schematic diagram of portion Z in FIG. 13.

FIG. 15 is a structural schematic diagram of a workbench in a support state in an embodiment of the present disclosure.

FIG. 16 is a structural schematic diagram of the workbench in FIG. 15 from a first angle of view.

FIG. 17 is a structural schematic diagram of the workbench in FIG. 15 from a second angle of view.

FIG. 18 is a structural sectional schematic view of the workbench along D-D line in FIG. 17.

FIG. 19 is an enlarged schematic diagram of portion L in FIG. 18.

FIG. 20 is a sectional schematic view of the workbench along E-E line in FIG. 17.

FIG. 21 is an enlarged schematic diagram of portion M in FIG. 20.

FIG. 22 is a structural schematic diagram of the workbench in FIG. 15 from a third angle of view.

FIG. 23 is a schematic diagram of a part of the workbench in FIG. 22.

FIG. 24 is an enlarged schematic diagram of portion Nin FIG. 23.

FIG. 25 is a partial schematic diagram of the workbench in FIG. 22.

FIG. 26 is an enlarged schematic diagram of portion P in FIG. 25.

FIG. 27 is a structural schematic diagram of a part of workbench in FIG. 22.

FIG. 28 is a structural schematic diagram of a workbench in the support state in FIG. 1.

FIG. 29 is a structural schematic diagram of the workbench in FIG. 28 from a first angle of view.

FIG. 30 is a structural schematic diagram of the workbench in FIG. 28 from a second angle of view.

FIG. 31 is a structural schematic diagram of the workbench in FIG. 28 from a third angle of view.

FIG. 32 is a sectional schematic view of the workbench along F-F line in FIG. 31.

FIG. 33 is a partial structural schematic diagram of the workbench in FIG. 28.

FIG. 34 is an enlarged schematic diagram of portion Q in FIG. 33.

Reference signs are as follows: 100 represents a workbench; 10 represents a bearing platform; 101 represents a bearing surface; 102 represents a back surface; 103 represents a first side; 104 represents a second side; 11 represents a first sliding groove; 12 represents a fourth sliding groove; 13 represents a fifth sliding groove; 14 represents a sixth sliding groove; 20 represents a supporting structure; 201 represents a first supporting structure; 202 represents a second supporting structure; 21 represents a supporting leg; 211 represents a mating groove; 22 represents a cross brace; 23 represents a lock groove; 30 represents a control member; 31 represents a connecting section; 32 represents a sliding section; 321 represents a positioning hole; 40 represents a connecting assembly; 401 represents a driving end; 4011 represents a second sliding groove; 402 represents a driven end; 4021 represents a third sliding groove; 410 represents a first moving member; 411 represents a second moving member; 412 represents a pin axle; 413 represents a first driven member; 414 represents a second driven member; 415 represents a driving block; 4151 represents a stopping portion; 4152 represents an inserting portion; 4153 represents a rotatable cylinder portion; 416 represents a driven block; 417 represents a first anti-disengaging member; 418 represents a second anti-disengaging member; 419 represents a support; 4191 represents a U-shaped groove; 42 represents a first connecting structure; 421 represents a transporting member; 4211 represents a driving section; 4212 represents a driven section; 4213 represents a fixing end; 4214 represents a fixing block; 422 represents a diverting member; 43 represents a second connecting structure; 50 represents an articulating rod; 60 represents a first locking structure; 61 represents a first housing; 62 represents a first trigger member; 63 represents a first force transmission member; 631 represents an auxiliary shaft; 632 represents a rotatable arm; 64 represents a first locking member; 65 represents a first elastic member; 70 represents a second locking structure; 701 represents an engagement space; 71 represent a second trigger member; 711 represents a guiding beveled edge; 72 represents a second locking member; 73 represents a second elastic member; 74 represents a sliding protrusion; 75 represents a locking block; 751 represents a locking protrusion; 76 represents a third elastic member; 77 represents a locking hook; 80 represents a rotatable rod; 81 represents a restricting groove; 82 represents a snap-ring shim; 83 represents a snap spring; 91 represents an accommodating portion; 911 represents an accommodating groove; 912 represents an accommodating hole; 92 represents a handle; 93 represents a F-shaped-clip guiding rail; 931 represents a guiding rail opening; 94 represents a limiting structure; 941 represents a pulling member; 942 represents a locking pin; 943 represents a fourth elastic member; and 95 represents a fixing member.

### DETAILED DESCRIPTION

The technical scheme in the embodiment of this application will be described clearly and completely with the attached drawings. Obviously, the described embodiment is only a part of the embodiment of this application, not the whole embodiment. Based on the embodiments in this application, all other embodiments obtained by ordinary technicians in this field without creative work belong to the protection scope of this application.

It should be noted that, when a member is considered “connected to” another member, it can be directly fixed to another member or there may be a centered member present simultaneously. When a member is considered “set on” another member, it can be directly set on another member or there may be a centered member present simultaneously. When a member is considered “fixed to” another member, it can be directly fixed to another member or there may be a centered member present simultaneously.

Unless otherwise defined, all technical and scientific terms used in this article have the same meanings as those commonly understood by those skilled in the art of the present disclosure. The terms used in the specification of the present disclosure are only for the purpose of describing specific embodiments and are not intended to limit the present disclosure. The term “and/or” used in this article includes any and all combinations of one or more related listed items.

When a workbench in the related art is used, a supporting structure at one side should be rotated to a preset position, and then a supporting structure at the other side should be rotated to a preset place, so that the workbench is switched to a supporting state convenient to use. When the workbench is switched from the support state to a folded state, the supporting structures at both sides of the workbench should be rotated to fold, respectively. This process is complex, and users have a poor experience.

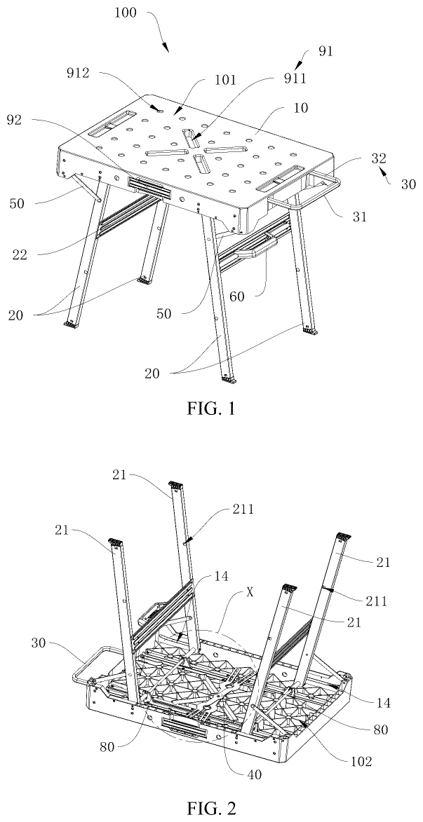

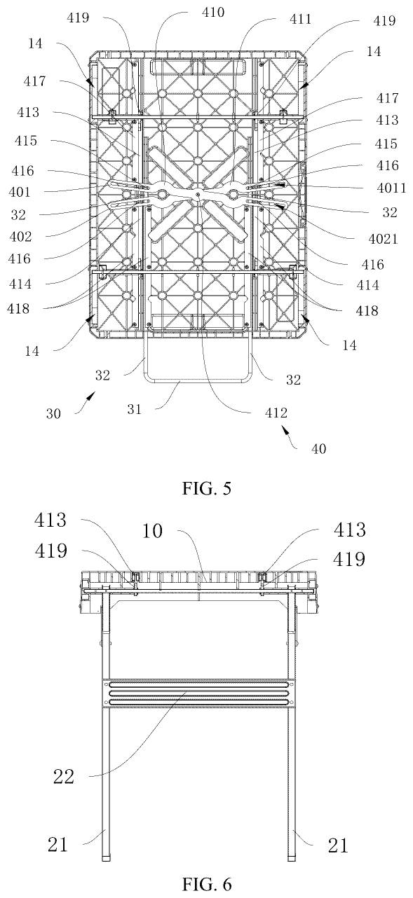

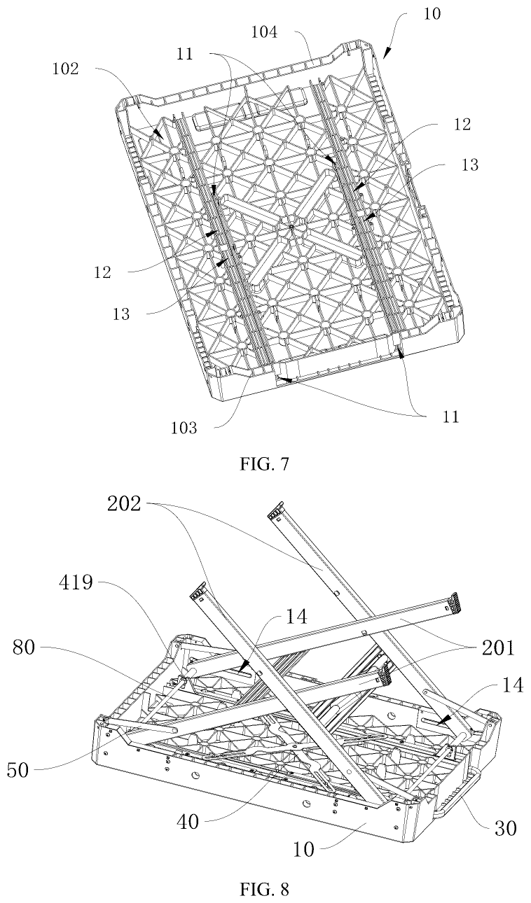

In view of above, a workbench 100 is provided. The workbench can be used in, but not limited to, scenes such as workshop maintenance, home life and so on. Referring to FIGS. 1 to 7, the workbench 100 includes a bearing platform 10, two supporting structures 20, a control member 30 and a connecting assembly 40. The bearing platform 10 includes a bearing surface 101 and a back surface 102 away from each other. The two supporting structures 20 are rotatably mounted on two opposite sides of the back surface 102, respectively. The control member 30 is connected to the bearing platform 10 and capable of moving relative to the bearing platform 10. The connecting assembly 40 is configured for connecting the control member 30 to the supporting structure 20. The control member 30 is capable of driving the two supporting structures 20 to rotate via the connecting assembly 40 under the action of an external force, such that the workbench 100 is capable of switching between a folded state or a support state. When the workbench 100 is in the folded state, both of the two supporting structures 20 are adjacent to the back surface. When the workbench 100 is in the support state, the two supporting structures 20 are configured to support the bearing platform 10. By such arrangement, in the workbench 100 of the present disclosure, the two supporting structures 20 can be unfolded or folded via the connecting assembly 40 and the same control member 30, such that the workbench 100 can be quickly switched between the support state to be used and the folded state to be stored, thereby significantly improving use comfort and convenience of the workbench 100.

Referring to FIGS. 1, 2, 5 and 7, in an embodiment, the bearing platform 10 is provided with a first sliding groove 11, and at least part of the control member 30 is slidably disposed in the first sliding groove 11. By such arrangement, a risk of shaking and twisting can be minimized or avoided when the control member 30 is pulled, thereby effectively improving moving stability of the control member 30.

Referring to FIG. 8, in an embodiment, the same control member 30 is capable of simultaneously driving the two supporting structures 20 to rotate inwards to the folded state. In other words, in the workbench 100 of the present disclosure, the two supporting structures 20 can be controlled to rotate outwards to the support state or to rotate inwards to the folded state by the same control member 30. The difficulty of driving the two supporting structures 20 to rotate outwards to unfold or inwards to fold by the same control member 30 lies in that the connecting assembly 40 should have a structure capable of driving the control member 30 to move bidirectionally.

Referring to FIGS. 1, 2, 8 and 9, in an embodiment, the workbench 100 further includes an articulating rod 50. One end of the articulating rod 50 is pivotally connected to one of the two supporting structures 20, and the other end of the articulating rod 50 is pivotally connected to the bearing platform 10. The two supporting structures 20 are connected to the bearing platform 10. The two supporting structures 20 are capable of sliding and rotating relative to the bearing platform 10. By providing the articulating rod 50, the two supporting structures 20 can rotate more stably relative to the bearing platform 10, so as to ensure that relative positions of the two supporting structures 20 and the bearing platform 10 are always located at preset positions when the workbench 100 is switched between the support state or the folded state.

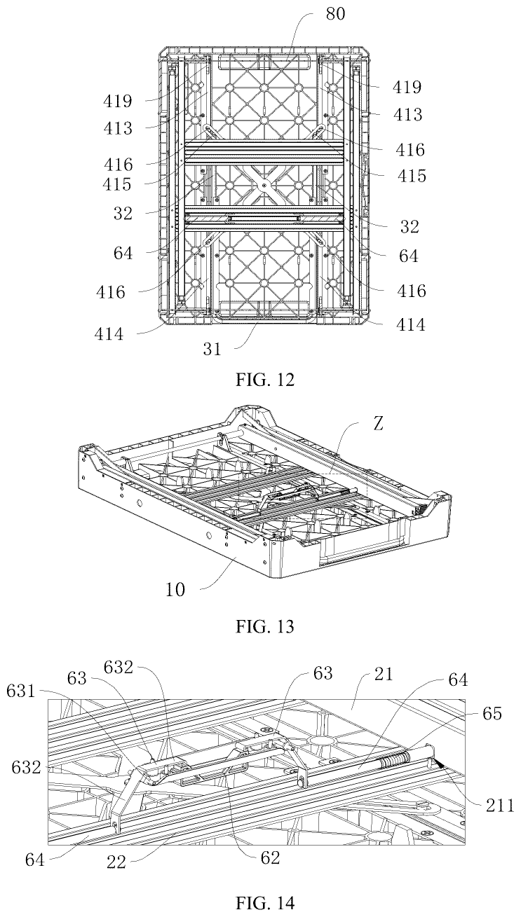

Referring to FIGS. 2 to 9, and FIGS. 10 to 12, for example, in an embodiment, the connecting assembly 40 includes a first movable member 410, a second movable member 420 and a pin axle 412. The first movable member 410 and the second movable member 411 are disposed in an interleaved manner. The first movable member 410 is pivotally connected to the second movable member 411 via the pin axle 412. The pin axle 412 is fixed to the bearing platform 10. Both ends of the first movable member 410 are connected to the two supporting structures 20, respectively. Both ends of the second movable member 411 are connected to the two supporting structures 20, respectively. The control member 30 is capable of sliding under the external force, so as to change a cross angle defined between the first movable member 410 and the second movable member 411, thereby allowing the first movable member 410 and the second movable member 411 to drive the two supporting structures 20 to rotate. By such arrangement, the first movable member 410 and the second movable member 411 arranged in a crossed manner can drive the two supporting structures 20 to rotate inwards or outwards, thereby switching the workbench 100 between the folded state and the unfolded state.

Referring to FIGS. 1 and 2, furthermore, each of the two supporting structures 20 includes two supporting legs 21. Two ends of the first movable member 410 are directly or indirectly connected to the two supporting legs 21 at two diagonal positions of the bearing platform 10, respectively, in which the two supporting legs 21 correspond to the two supporting structures 20, respectively. Correspondingly, two ends of the second movable member 411 are directly or indirectly connected to two supporting legs 21 at the other two diagonal positions of the bearing platform 10, respectively. By such arrangement, when the first movable member 410 and the second movable member 411, which are connected to each other in a crossed manner, rotate, the two supporting structures 20 can be synchronously driven to rotate relative to each other or rotate away from each other, so as to synchronous fold or unfold the two supporting structures 20.

Referring to FIGS. 2 to 5, in the present embodiment, both the end of the first movable member 410 adjacent to the control member 30 and the end of the second movable member 411 adjacent to the control member 30 are connected to one of two supporting structures 20 disposed at a side of the bearing platform 10 adjacent to the control member 30.

In an embodiment, a driving end 401 is defined by an end of the first movable member 410 away from the control member 30 and an end of the second movable member 411 away from the control member 30. A driven end 402 is defined by an end of the first movable member 410 adjacent to the control member 30 and an end of the second movable member 411 adjacent to the control member 30. Referring to FIGS. 2 to 5, the connecting assembly 40 further includes two first driven members 413 and two second driven members 414. The two first driven members 413 are slidably disposed on the back surface 102 of the bearing platform 10. The two first driven members 413 are slidably connected to the driving end 401 of the first movable member 410 and the driving end 401 of the second movable member 411, respectively. The two first driven members 413 are rotatably connected to one of the two supporting structure 20 relatively away from the control member 30. The two second driven members 414 are slidably disposed on the back surface 102 of the bearing platform 10. The two second driven members 414 are slidably connected to the driven end 402 of the first movable member 410 and the driven end 402 of the second movable member 411, respectively. The second driven members 414 are rotatably connected to one of the two supporting structures 20 relatively adjacent to the control member 30. By such arrangement, an acting force applied to the control member 30 can be transmitted to the two supporting structures 20 via the two first driven members and the two second driven members, and it is more convenient to control the two supporting structures 20 and switch the workbench 100 between the support state and the folded state.

It should be noted that both “relatively adjacent to” and “relatively away from” are based on a position of the pin axle 412.

Referring to FIGS. 2 to 7, in an embodiment, both the driving end 401 of the first movable member 410 and the driving end 401 of the second movable member 411 are provided with a second sliding groove 4011. Both the driven end 402 of the first movable member 410 and the driven end 402 of the second movable member 411 are provided with a third sliding groove 4021. The connecting assembly 40 further includes a driving block 415 and two driven blocks 416. The driving block 415 protrudes from the control member 30 and is slidably disposed on the second sliding groove 4011. One of the two driven blocks 416 protrudes from the first driven member 413 and is slidably disposed in the second sliding groove 4011, and the other one of the two driven blocks 416 protrudes from the second driven member 414 and is slidably disposed in the third sliding groove 4021. By such arrangement, the control member 30 can drive the first movable member 410 and the second movable member 411 to cross and rotate via the driving block 415. The first movable member 410 and the second movable member 411 can drive the first driven member 413 and the second driven member 414 to slide via the driven block 416, respectively. The first driven member 413 and the second driven member 414 can drive the two supporting structures 20 to rotate, so that the two supporting structures 20 can be controlled to synchronously unfold or fold by the same control member 30.

In the present embodiment, a rotation process of the two supporting structures 20, includes multiple times of transmission conversion. Firstly, sliding of the control member 30 is converted to rotation of the first movable member 410 and rotation of the second movable member 411; then the rotation of the first movable member 410 and the rotation of the second movable member 411 is converted to sliding of the first driven member 413 and sliding of the second driven member 414; and finally, the sliding of the first driven member 413 and the sliding of the second driven member 414 is converted to the rotation of the two supporting structures 20. By such arrangement, it is convenient to control and arrange an overall structure of the workbench 100.

Furthermore, the driving block 415 detachably protrudes from the control member 30. One of the two driven blocks 416 detachably protrudes from the first driven member 413, and the other one of the two driven blocks 416 detachably protrudes from the second driven member 414. By such arrangement, assembly and maintenance of each part of the workbench 100 can be convenient. A manner of detachable connection includes, but is not limited to, a threaded connection. In other words, in some embodiments, the driving block 415 may be threadedly connected to the operating member 30, and the driven block 416 may be threadedly connected to the first driven member 413 or the second driven member 414.

A depth of threaded connection between the driving block 415 and the driven block 416 is required to ensure that the first movable member 410 and the second movable member 411 can normally cross and move. Meanwhile, the driving block 415 is required not to fall out of the second sliding groove 4011, and the two driven blocks 416 are required not to fall out of the second sliding groove 4011 and the third sliding groove 4021, respectively.

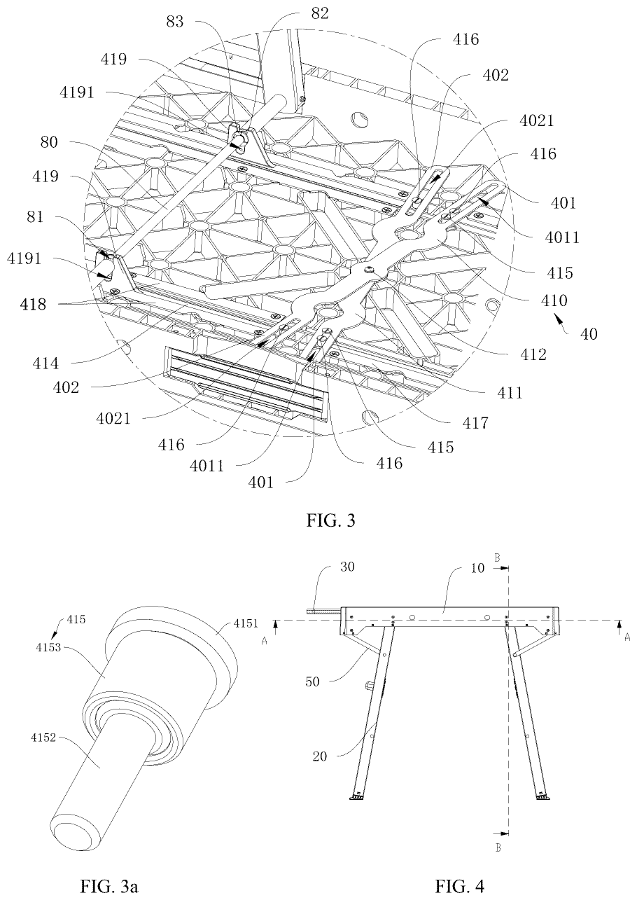

Referring to FIG. 3a, in the present embodiment, the driving block 415 includes a restricting portion 4151 and an insertion portion 4152 connected to each other. A size of the restricting portion 4151 is greater than a width of the second sliding groove 4011. The restricting portion 4151 is configured to prevent the driving block 415 from falling out of the second sliding groove 4011. A size of the insertion portion 4152 is smaller than the width of the second sliding groove 4011. The insertion portion 4152 is configured to extend through the second sliding groove 4011 to connect the control member 30, and a distance between the restricting portion 4151 and the control member 30 is slightly greater than thicknesses of the first movable member 410 and the second movable member 411, such that the first movable member 410 and the second movable member 411 can normally rotate in the crossed manner.

Furthermore, the driving block 415 further includes a rotatable cylinder portion 4153 rotatably sleeved on the inserting portion 4152. A size of the rotatable cylinder portion 4153 is smaller than or equal to a width of the second sliding groove 4011. The rotatable cylinder portion 4153 is configured for reducing resistance and wear generated between the driving block 415 and the first movable member 410 and/or between the driving block 415 and the second movable member 411 when the first movable member 410 and the second movable member 411 rotate in the crossed manner, so as to improve rotation smoothness and prolong a service life of the first movable member 410 and the driving block 415.

Referring to FIGS. 3 and 3a, furthermore, a structure of the driven block 416 is the same as a structure of the driving block 415. A matching relationship between the driven block 416 and the first movable member 410, the second movable member 411, the second movable groove and the third movable groove may refer to a matching relationship between the driving block 415, the control member 30 and the second sliding groove 4011, which is not repeated herein.

Referring to FIGS. 2 to 12, in an embodiment, the connecting assembly 40 further includes a first anti-disengaging member 417. A fourth sliding groove 12 is provided on the back surface 102 of the bearing platform 10. The fourth sliding groove 12 extends along a sliding direction of the control member 30. The first driven member 413 is slidably disposed in the fourth sliding groove 12. The first anti-disengaging member 417 is disposed on the back surface 102 of the bearing platform 10 and covers at least part of the fourth sliding groove 12, so as to prevent the first driven member 413 from falling out of the fourth sliding groove 12. Alternatively, the connecting assembly 40 further includes a second anti-disengaging member 418. A fifth sliding groove 13 is provided on the back surface 102 of the bearing platform 10. The fifth sliding groove 13 extends along the sliding direction of the control member 30. The second driven member 414 is slidably disposed in the fifth sliding groove 13, and the second anti-disengaging member 418 is disposed on the back surface 102 of the bearing platform 10 and covers at least part of the fifth sliding groove 13, so as to prevent the second driven member 414 from falling out of the fifth sliding groove 13. By such arrangement, when the two supporting structures 20 rotates, by providing the first anti-disengaging member 417 and the second anti-disengaging member 418, the first driven member 413 and the second driven member 414 can stably slide in the fourth sliding groove 12 and the fifth sliding groove 13, respectively, and would not fall out of the fourth sliding groove 12 and the fifth sliding groove 13.

Referring to FIGS. 2 to 5 and FIG. 7, for example, in the present embodiment, the number of the first anti-disengaging member 417 is one, and the number of the second anti-disengaging member 418 is two. One of the two second anti-disengaging members 418 is mounted on the back surface 102 of the bearing platform 10 and covers at least part of the fifth sliding groove 13, so as to prevent the second driven member 414 from falling out of the fifth sliding groove 13, and the other one of the two second anti-disengaging members 418 is mounted on the back surface 102 of the bearing platform 10 and covers at least part of the first sliding groove 11, so as to prevent the control member 30 from falling out of the first sliding groove 11. In other embodiments, the number of the first anti-disengaging member 417 and the number of the second anti-disengaging member 418 is not limited, as long as the first anti-disengaging member 417 and the second anti-disengaging member 418 can play a role of anti-disengaging and does not affect a transmission performance.

Furthermore, in the present embodiment, a peripheral side of the back surface 102 of the bearing platform 10 is provided with a side wall, an accommodating space can be defined between the side wall and the back surface 102 of the bearing platform 10. In the folded state, the two supporting structures 20 can be accommodated in the accommodating space, so as to facilitate packaging and improve a safety of the connecting assembly 40 and the two supporting structure 20 during a transportation process.

Referring to FIGS. 2 to 5, furthermore, each of the two side surfaces parallel to a sliding direction of the control member 30 are provided with a sixth sliding groove 14, respectively. Two ends of a rotatable rod 80 can slide and rotate in the sixth sliding groove 14. The sixth sliding groove 14 can assist the rotatable rod 80 in sliding and rotating to prevent a sliding direction of the rotatable rod 80 from deviating, thereby ensuring that the rotatable rod 80 is more stable and reliable when the rotatable rod 80 drives the supporting structure 20 to rotate. In some embodiments, the sixth sliding groove 14 may be disposed on the back surface 102 of the bearing platform 10. The first sliding groove 11, the second sliding groove 4011, the third sliding groove 4021, the fourth sliding groove 12, the fifth sliding groove 13 and the sixth sliding groove 14 include, but are not limited to, stripe-shaped blind holes, stripe-shaped through holes or elongated kidney-shaped holes. Extending directions of the first sliding groove 11, the second sliding groove 4011, the third sliding groove 4021, the fourth sliding groove 12, the fifth sliding groove 13 and the sixth sliding groove 14 are the same while being the same as a sliding direction of the control member 30. In the present embodiment, the sliding direction of the control member 30 is the same as a length direction of the bearing platform 10, and the above sliding grooves are all provided along the length direction of the bearing platform 10.

Referring to FIGS. 1 to 5, in an embodiment, the workbench 100 further includes two rotatable rods 80. The connecting assembly 40 further includes two supports 419. One of the two supports 419 is disposed on the first driven member 413, and the other one of the two supports 419 is disposed on the second driven member 414. One of the two rotatable rods 80 is fixed on one of the two supporting structures 20 and rotatably connected to the first driven member 413 via one of the two supports 419, and the other one of the two rotatable rods 80 is fixed on the other one of the two supporting structures 20 and rotatably connected to the second driven member 414 via the other one of the two supports 419. By such arrangement, the two supporting structures 20 can be more stable in a rotation process by an assistance of the two rotatable rods 80 and the two supports 419. In some embodiments, the first driven member 413 and the second driven member 414 may be directly rotatably connected to the two supporting structures 20, respectively, or may be indirectly and rotatably connected to the two supporting structures 20 via other structures, which is not limited to be assisted by the two rotatable rods 80 and the two supports 419.

Referring to FIGS. 2 and 3, in an embodiment, an external surface of the rotatably rod 80 is provided with a ring-shaped restricting groove 81. Both of the two supports 419 are provided with a U-shaped groove 4191. The two rotatable rods 80 are extend into the U-shaped groove 4191 through the correspondingly restricting groove 81. The support 419 extend into the corresponding restricting groove 81. The rotatable rod 80 is rotatably disposed on the support 419 via the restricting groove 81. By such arrangement, the rotatable rod 80 can be more stably in fit with the corresponding the support 419. The two supporting structures 20 can rotate more stably by a transmission effect among the connecting assembly 40, the two rotatable rods 80 and the two supports 419, such that the two supporting structures 20 can be switched between the support state or the folded state. The restricting groove 81 is, but is not limited to, in a ring-shaped or in a circular arc-shaped, as long as a rotation angle defined by one of the two rotatable rods 80 on the corresponding the support 419 meets a requirement.

Referring to FIG. 3, the restricting groove 81 may be directly disposed on the rotatable rods 80; alternatively, the restricting groove 81 may be defined by cooperation between the rotatable rods 80 and elements such as the engaging assembly and so on, as long as the rotatable rods 80 can rotate stably on the supports 419. In the present embodiment, the engaging assembly includes a snap-ring shim 82 and a snap spring 83. The rotatable rod 80 includes a large-diameter section and a small-diameter section. Both the snap spring 83 and the snap-ring shim 82 are sleeved on the small-diameter section of the rotatable rod 80, and the restricting groove 81 is defined between the snap-ring shim 82 of the rotatable rods 80 and the large-diameter section of the rotatable rods 80. The large-diameter section of the rotatable rods is configured for connecting the two supporting legs 21, so as to ensure connection strength and support strength of the two supporting legs.

In the present embodiment, the first movable member 410, the pin axle 412 and the second movable member 411 are disposed in a central area of the back surface 102 of the bearing platform 10. The two supporting structures 20 are located on two opposite sides of the back surface 102 of the bearing platform 10, respectively. The control member 30 is disposed on one side of the bearing platform 10, and a sliding direction of the control member 30 is consistent with a length direction or a width direction of a top surface of the bearing platform 10. In other words, the first sliding groove 11 penetrates through one side surface of the bearing platform 10, facilitating pulling the control member 30 from the side of the bearing platform 10.

Referring to FIGS. 1 to 7, furthermore, in the present embodiment, the bearing platform 10 includes a first side 103 and a second side 104 away from each other. The two supporting structures 20 are disposed at the first side 103 of the bearing platform 10 and the second side 104 of the bearing platform 10, respectively. The control member 30 is disposed at the first side 103 of the bearing platform 10.

Referring to FIG. 1, in an embodiment, each of the two supporting structures 20 further includes at least one cross brace 22. Two ends of each of the at least one cross brace 22 are connected to the two supporting legs 21, in which the two supporting legs correspond to the same set of the two supporting structure 20. The at least one cross brace 22 can enhance support strength of each of the two supporting structures 20.

Furthermore, in the present embodiment, the supporting legs 21 in different set of supporting structures 20 are arranged in a staggered. By such arrangement, when the supporting legs 21 of one of the two supporting structures 20 rotate relative to the supporting legs 21 of the other one of the two supporting structures 20, the sticking of supporting legs 21 can be avoided.

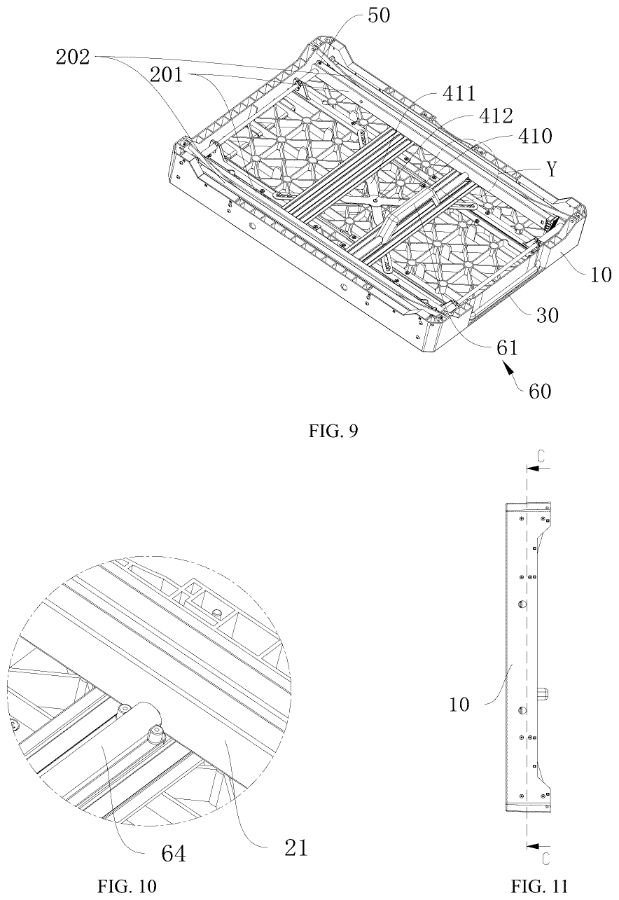

Referring to FIGS. 8 and 9, in some embodiments, the supporting structure 20 includes a first supporting structure 201 and a second supporting structure 202. When the workbench 100 is in the folded state, the two supporting legs 22 of the first supporting structure 201 are disposed inside the two supporting legs 21 of the second supporting structure 202. In other embodiments, when the workbench 100 is in the folded state, the two supporting legs 21 in the first supporting structure 201 and the two supporting legs 21 in the second supporting structure 202 may be arranged in a staggered manner. In other words, in the same set of the supporting structures 20, one of the two supporting legs 21 is disposed at an inner side, and the other one of the two supporting legs 21 is disposed at an external side.

Referring to FIGS. 9 to 12 and FIGS. 13 to 14, in an embodiment, the workbench 100 further includes a first locking structure 60. The first locking structure 60 is disposed on the at least one cross brace 22 of the second supporting structure 202. The first locking structure 60 is capable of elastically abutting against the two supporting legs 21 of the first supporting structure 201, such that the workbench 100 can be remained in the folded state. By such arrangement, the two supporting structures 20 can be locked via the first locking structure 60, so that the workbench 100 can be remained in the folded state, facilitating transportation and storage of the workbench 100. In some embodiments, the first locking structure 60 may be disposed on the cross brace 22 of the two supporting legs 21 of the first supporting structure 201, as long as the workbench 200 is provided with a corresponding structure to allow the first locking structure 60 to elastically abut against the supporting leg 21 of the second supporting structure 202.

Referring to FIGS. 13 and 14, in an embodiment, the first locking structure 60 includes a first housing 61, a first trigger member 62, two first transmission members 63, two first locking members 64 and two first elastic members 65. The first housing 61 is fixed on the at least one cross brace 22. The first trigger member 62, the two first transmission members 63 and the two first locking members 64 are all disposed on the first housing 61 and capable of moving relative to the first housing 61. The two first transmission members 63 are connected to two sides of the first trigger member 62, respectively. Each of the two first locking structures 64 is connected to a side of one of the two first transmission members 63 away from the first trigger member 64. The two first elastic members 65 act on the two first locking structures 64, respectively. The two first locking structures 64 are capable of extending out of the first housing 61 and elastically abutting against the two supporting legs 21, respectively.

The first trigger member 62 is capable of moving under the action of the external force and driving the two first locking members 64 to move via the two first transmission members 63, such that the two first locking members 64 can separate from the two supporting legs 21. By such arrangement, the two supporting legs 21 disposed at two sides of the first locking structure 60 can be unlocked by the same first trigger member 62. Specifically, when the two supporting legs 21 are about to unlock, the first trigger member 62 is pressed under the action of the external force, and the first trigger member 62 can press against one end of each of the two first transmission members 63 to drive the two first transmission members 63 to rotate with the auxiliary rotating shaft 631 as a fulcrum, so as to allow the other end of each of the two first transmission members 64 to drive the first locking member 64 to move towards a middle or center to unlock the two supporting legs 21. After the external force is removed, the two first locking members 64 can be reset under the action of the two first elastic members 65, respectively.

The first force transmission member 63 has two rotatable arms 632, and an inclination angle can be defined by each of the two rotatable arms 632. The inclination angle may be an obtuse angle. The auxiliary rotating shaft 631 is configured to provide a rotating fulcrum for the two rotatable arms 632, so that rotating directions of the two ends of the first transmission member 63 are different, so as to drive the first locking member 64 to move toward a middle or center to unlock the workbench 100. In some embodiments, the first force transmission member 63 may not be provided, so that the first trigger member 62 is directly connected to the first locking member 64. In the present embodiment, a holding space is defined be between the first trigger member 62 and each cross brace 22 by providing the two first transmission members 63, facilitating a user extending the hand into the first trigger member 62 to apply force on the first trigger member 62.

Referring to FIGS. 2 and 10, in an embodiment, the two supporting legs 21 of the first supporting structure 201 is provided with a mating groove 211, and the first locking member 64 can extend into the mating groove 211 and elastically abut against a groove wall of the mating groove 211.

In the present embodiment, the two supporting legs 21 of the first supporting structure 201 are provided with the mating grooves 211. Two opposite ends of the two first locking members 64 can extend into two mating grooves 211, respectively, and elastically abut against the groove walls of the two mating grooves 211, respectively. In some embodiments, only one first locking member 64 may be provided, and one of the two supporting legs 21 of the first supporting structure 201 is provided with the mating groove 211 for matching. In other words, the two supporting legs 21 on one side of the workbench 100 or the two supporting legs 21 on two sides of the workbench 100 may be selectively locked as required. Furthermore, in some embodiments, the first locking structure 60 may be disposed on the cross brace 22 of to the two supporting legs 21 of the first supporting structure 201, the supporting leg 21 of the first supporting structure 201 can be provided with inserting holes, and the mating groove 211 can be provided on the two supporting legs 21 of the second supporting structure 202, as long as the first locking member 64 can penetrate through the inserting holes and elastically abut against the groove wall of the mating groove 211.

Referring to FIG. 1, in the present embodiment, the bearing platform 10 is further provided with a storage portion 91. The accommodating portion 91 includes an accommodating groove 911 and an accommodating hole 912 which are both disposed on the bearing platform 10. The accommodating groove 911 can cooperate with a power tool. The power tool includes, but is not limited to, a cutting saw, an electric drill and so on. The accommodating hole 912 can cooperate with a maintenance tool, such as a clamp and so on.

Referring to FIG. 1, furthermore, in the present embodiment, the bearing platform 10 is further provided with a handle 92, and the handle 92 facilitates the user carrying and moving the workbench 100. The handle 92 may be disposed on an outer side wall of the bearing platform 10.

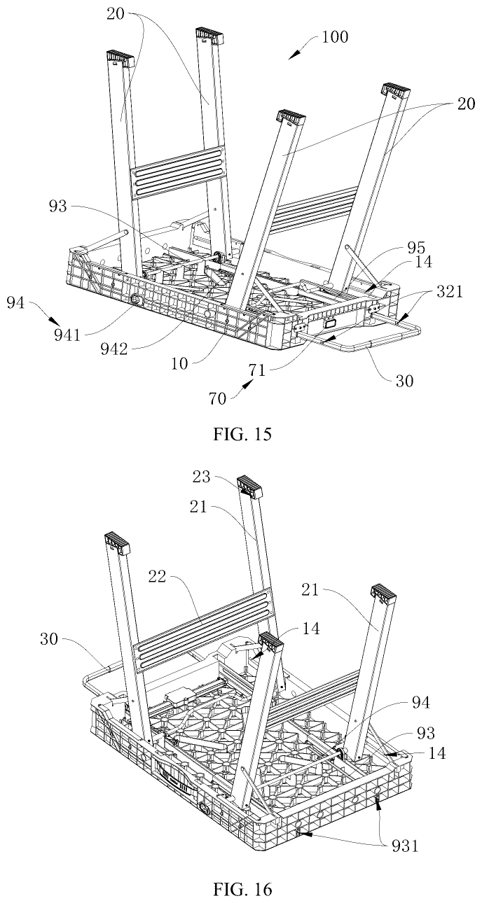

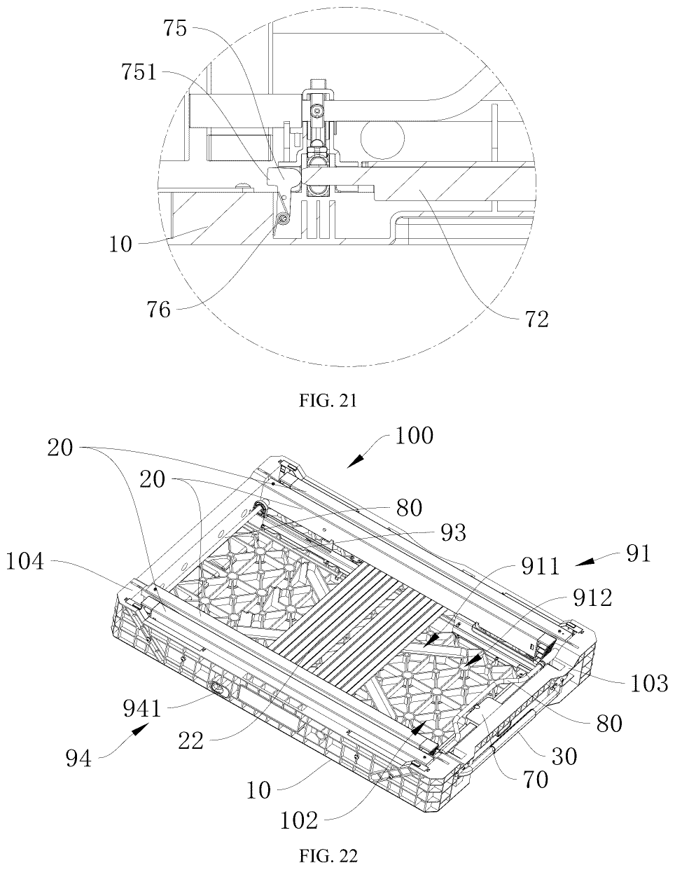

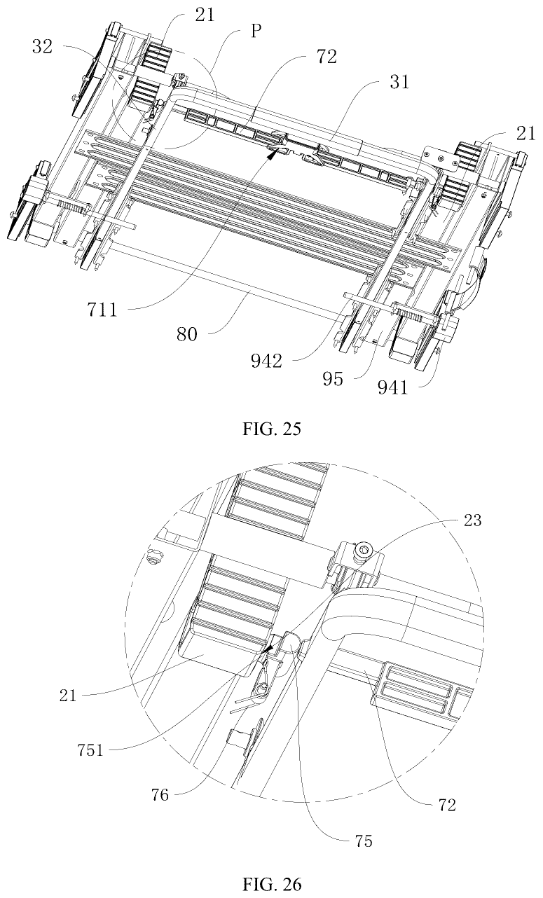

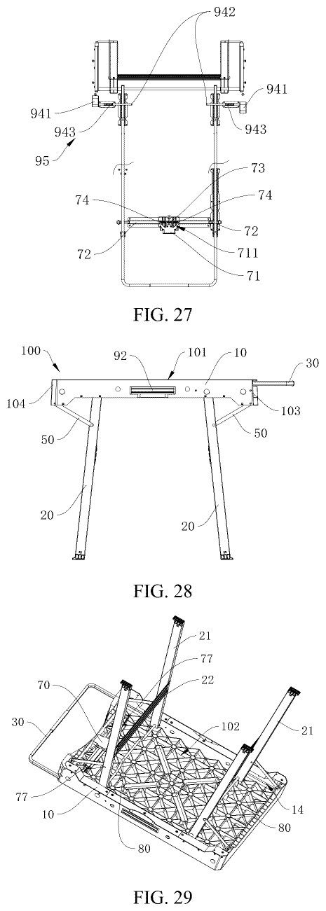

Referring to FIGS. 15 to 27, in the present disclosure, a second embodiment is provided, and an inventive concept and most of structures of the workbench 100 in the second embodiment are the substantially the same as those of the workbench 100 in the first embodiment, except for the following features. In the second embodiment, a connecting assembly 40 includes a first connecting structure 42 and a second connecting structure 43. The control member 30 is connected to the supporting structures 20 disposed at a first side 103 of the bearing platform 10 via the first connecting structure 42. The control member 30 is connected to the supporting structures 20 disposed at a second side 104 of the bearing platform 10 via the second connecting structure 43. When the control member 30 slides along a preset direction under the action of the external force, the first connecting structure 42 is configured for driving an end of the supporting structures 20 disposed at the first side 103 adjacent to the bearing platform 10 to move along a direction away from the preset direction, and the second connecting structure 43 is configured for driving an end of the supporting structures 20 disposed at the second side 104 adjacent to the bearing platform 10 along the preset direction.

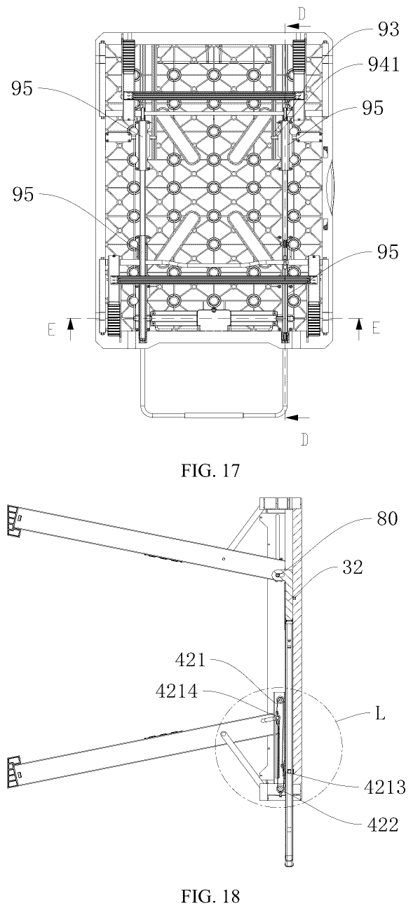

Referring to FIGS. 17 to 19, for example, in the present embodiment, the first connecting structure 42 includes a conveyor member 421 and a diverting member 422. The conveyor member 421 is connected to the diverting member 422. The diverting member 422 is configured to change a direction of the conveyor member 421. The conveyor member 421 is divided into a driving section 4211 and a driven section 4212 by the diverting member 422. A direction of movement of the driving section 4211 is opposite to a direction of movement of the driven section 4212. The control member 30 is connected to the driving section 4211, and the first side 103 of the supporting structure 20 is connected to the driven section 4212.

The conveyor member 421 may be a conveyor belt, a conveyor rope, a conveyor chain, a conveyor rack, and so on. In the present embodiment, the conveyor member 421 can be a conveyor rope. Furthermore, the conveyor member 421 can be a conveyor rope made of a steel wire. By such arrangement, a service life of the conveyor member 421 can be prolonged.

In the present embodiment, the conveyor member 421 is annular-shaped and connected end to end. Furthermore, the conveyor member 421 is in a smooth ring shape and connected end to end. By such arrangement, sliding and direction-changing of the transfer member 421 can be more convenient. In some embodiments, the conveyor member 421 may not be provided with two ends; in other words, the conveyor member 421 may be a ring-shaped member without a fracture. In some embodiments, the conveyor member 421 may not be in ring-shaped, as long as the conveyor member 421 can play a role in conveying.

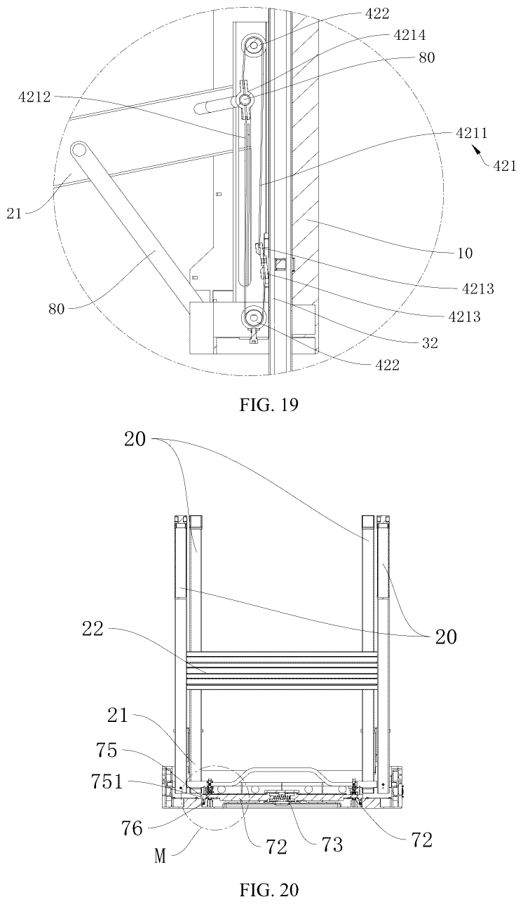

Referring to FIG. 19, in the present embodiment, the number of the diverting member 422 may be two, and both of the two diverting members 422 can be rollers. By providing the rollers as the two diverting members 422, it is more convenient to change the direction of the conveyor member 421. In some embodiments, the number of the diverting member 422 may be one, especially when the conveyor member 421 is in a non-annular shape.

Referring to FIG. 19, in an embodiment, the conveyor member 421 includes two fixed ends 4213. The two fixed ends 4213 are disposed at the head end of the conveyor member 421 and the tail end of the conveyor member 421. The two fixed ends 4213 are fixed to each other and fixed to the control member 30. By such arrangement, it can be ensured that the conveyor member 421 can move with the control member 30 to drive the two supporting structures 20 to rotate. Meanwhile, the two fixed ends 4213 are fixed to each other and fixed to the control member 30, such that other parts of the conveyor member 421 can define a smooth and continuous rope, and the phenomenon of jamming is not easy to occur when the diverting member 422 moves and diverts. In some embodiments, the two fixed ends 4213 may be directly fixed on the control member 30, as long as the control member 30 can drive the conveyor member 421 to slide and divert on the diverting member 422.

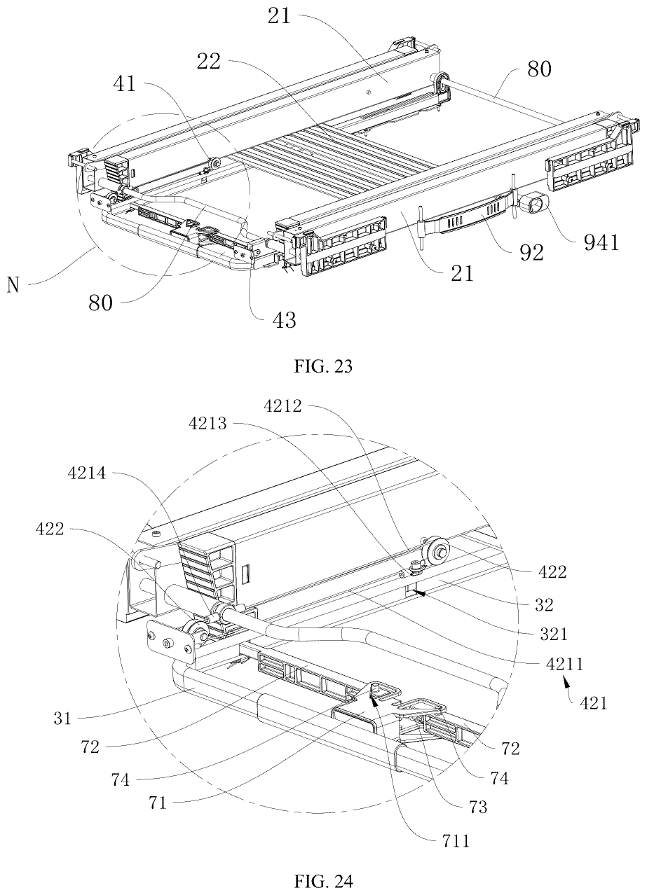

Referring to FIGS. 23 and 24, furthermore, in the present embodiment, the second connecting structure 43 is the same as the first connecting structure 42, and the control member 30 simultaneously drives the two supporting structures 20 to rotate via the first connecting structure 42 and the second connecting structure 43, respectively.

Referring to FIG. 22, in the present embodiment, the workbench 100 includes two rotatable rods 80. One of the two rotatable rods 80 is fixed on one of the two supporting structures 20, and the other one of the two rotatable rods 80 is fixed on the other one of the two supporting structures 20. The two supporting structures 20 are connected to the first connecting structure 42 and the second connecting structure 43 via the two rotatable rods 80, respectively.

Referring to FIGS. 18, 19, 23 and 24, furthermore, the conveyor member 421 further includes a fixing block 4214. The fixing block 4214 is disposed on the driven section 4212 of the conveyor member 421. The fixing block 4214 is rotatably connected to one of the two rotatable rods 80 disposed at the first side 103 of the bearing platform 10. The fixing block 4214 is configured for playing a guiding role for the conveyor member 421, so that the conveyor member 421 can move more stably with the control member 30, thereby reversing on the two diverting members 422. The fixing block 4214 is fixed on the conveyor member 421. When the control member 30 slides, the fixing block 4214 do not move relative to the conveyor member 421.

Referring to FIG. 15, in the present embodiment, the bearing platform 10 is further provided with a sixth sliding groove 14. The sixth sliding groove 14 extends along a movement direction of the control member 30. The rotatable rod 80 is slidably and rotatably connected to the sixth sliding groove 14 and rotatably connected to the control member 30. By such arrangement, the control member 30 can drive the set of supporting structures 20 away from the control member 30 to rotate stably. The sixth sliding groove 14 may be disposed on a side wall of the bearing platform 10, or may be disposed on a back surface 102 of the bearing platform 10, as long as the sixth sliding groove 14 can fit with the two rotatable rods 80 to assist the two supporting structures 20 to rotate and slide more stably.

Referring to FIGS. 15, 16, 17, 20, 21, 25 and 26, furthermore, in the present embodiment, the workbench 100 further includes a second locking structure 70. The second locking structure 70 is disposed on the bearing platform 10. The second locking structure 70 is capable of abutting against or separating from the control member 30, so that the control member 30 can be locked in the folded state and/or the support state.

In some embodiments, the second locking structure 70 is capable of locking the control member 30 in the folded state. Alternatively, in some embodiments, the second locking structure 70 has a function of locking the control member 30 in the support state. Alternatively, in an embodiment, the second locking structure 70 has both a function of locking the control member 30 in the folded state and a function of locking the control member 30 in the support state.

Referring to FIGS. 23 to 26, for example, in the present embodiment, the second locking structure 70 includes a second trigger member 71, a second elastic member 73 and a second locking member 72. The second locking member 72 is connected to the second trigger member 71. The second elastic member 73 is connected to and elastically act on the second locking member 72. The second trigger member 71 is capable of moving under the action of the external force and driving the second locking member 72 to move, such that the second trigger member 72 is capable of abutting against or separating from the control member 30. By such arrangement, the two supporting structures 20 can be remained in the support state or the folded state by locking the control member 30.

Referring to FIGS. 23, 24 and 27, in an embodiment, the number of the second locking member 72 is two, the two second locking members 72 are disposed at two sides of the second trigger member 71, respectively. The control member 30 includes a connecting section 31 and two sliding sections 32, and the two sliding sections are obliquely disposed relative to the connecting section 31. The two sliding sections 32 are connected to two ends of the connecting section 31, respectively, and each of the two sliding sections 32 is provided with at least two positioning holes 321. When the workbench 100 is in the support state and/or the folded state, the second locking member 72 can be elastically engaged in different positioning holes 321. By such arrangement, the two second locking members 72 can be engaged in the two positioning holes 321 in the two sliding sections 32 of the control member 30, respectively, so as to enhance a locking effect for the control member 30, thereby further ensuring that the control member 30 can be remained in the folded state or the support state. In some embodiments, each of the two sliding sections 32 can be provided with a plurality of positioning holes 321, and the plurality of corresponding adjustment positions can be defined by the plurality of positioning holes 321, so as to adjust a folded height of the workbench 100.

Furthermore, the positioning hole 321 may be a through hole or a blind hole, as long as a locking effect on the control member 30 is not affected. The number of the second locking member 72 can be one, the only one second locking member 72 can be configured to lock one side of the control member 30. Furthermore, the control member 30 can be, but be not limited to, in a U shape.

Referring to FIGS. 15, 23 and 24, in some embodiments, the second locking member 72 is slidably disposed on the bearing platform 10. The second trigger member 71 is disposed on the bearing platform 10, and capable of being pressed. An inclination angle is defined between a sliding direction of the second locking member 72 and a pressing direction of the second trigger member 71. Furthermore, the second triggering member 71 is provided with a beveled guiding edge 711. The second locking structure 70 further includes a sliding protrusion 74. The sliding protrusion 74 protrudes from the second locking member 72. The sliding protrusion 74 is slidably connected to the beveled guiding edge 711. The second trigger member 71 is capable of being pressed under the action of the external force, and then the beveled guiding edge 711 can drive the second locking member 72 to move via the sliding protrusion 74, such that the second locking member 72 can abut against or separate from the control member 30. By such arrangement, the second locking member 72 can quickly extend into the positioning hole 321 by pressing the second triggering member 71, so as to lock the control member 30.

Furthermore, in the present embodiment, when the workbench 100 is in the folded state, the second locking structure 70 is capable of preventing the two supporting structures 20 from separating from the back surface 102 of the bearing platform 10, such that the two supporting structures 20 can be remained in the folded state. In other words, in the present embodiment, the second locking structure 70 can not only lock the control member 30, but also lock the two supporting legs 21.

In the present embodiment, in the folded state, at least part of one of the two supporting structures 20 is capable of pressing the other one of the two supporting structures 20. The other one of the two supporting structures 20, which is pressed, is located outside the one of the two supporting structures 20. By such arrangement, a movement of the two supporting structures 20 can be restricted by only locking the two supporting legs 21 disposed inside. In the present embodiment, the cross brace 22 of one of the two supporting structures 20 is pressed on the other one of the two supporting structures 20.

Referring to FIGS. 17, 20, 21, 25 and 26, in the present embodiment, the control member 30 is provided with a positioning hole 321, and the positioning hole 321 is a through hole. The supporting structure 20 is provided with a locking groove 23. The second locking structure 70 further includes a locking block 75 and a third elastic member 76. The locking block 75 is movably mounted on the bearing platform 10. The third elastic member 76 is mounted on the bearing platform 10 and elastically acts on the locking block 75, so that the locking block 75 has a trend to move towards the second locking member 72. When the workbench 100 in the folded state, the second locking member 72 can extend out of the positioning hole 321 and drive the locking block 75 to move, and the locking block 75 can extend into the locking groove 23, so as to block one of the two supporting structures 20 disposed inside from separating from the back surface 102 of the bearing platform 10. The second trigger member 71 can drive the second locking member 72 to move in a direction relatively away from the locking block 75 under the action of an external force, and the locking block 75 is capable of separating from the locking groove 23 under an elastic action of the third elastic member 76, so that the two supporting structures 20 can be switched from the folded state to the support state. By such arrangement, the second locking structure 70 can lock the two supporting legs 21 via the locking block 75 and the third elastic member 76, such that structures of the workbench 100 can be remained stable and hard to move in the support state or the folded state.

Furthermore, in the present embodiment, the locking block 75 is rotatably disposed on the bearing platform 10. The locking block 75 has a locking protrusion 751. The locking protrusion 751 can extend into the locking groove 23. Furthermore, the third elastic member 76 may be a torsion spring.

Referring to FIGS. 15, 16, 17, 25, and 27, furthermore, in order to facilitate use, the bearing platform 10 can be provided with an F-shaped-clip guiding rail 93, a limiting structure 94, and a fixing member 95, so as to further expand a use scenario of the workbench 100 and meet more use requirements. Specifically, in the present embodiment, the F-shaped-clip guiding rail 93 includes a guiding rail opening 931. The guiding rail opening 931 is disposed on a side of the bearing platform 10 relatively away from to the control member 30. The limiting structure 94 includes a pulling member 941, a lock pin 942, and a fourth elastic member 943 that are matched with each other. The lock pin 942 can be inserted into the F-shaped-clip guiding rail 93 from a side of the workbench 100. The pulling member 941 can pull out the lock pin 942 from the F-shaped-clip guiding rail 93 under the action of an external force. The fourth elastic member 943 can reset the lock pin 942 after the external force is removed, so that the locking effect of the lock pin 942 is realized again, and detailed use steps in a specific scenario are not described in detail herein.

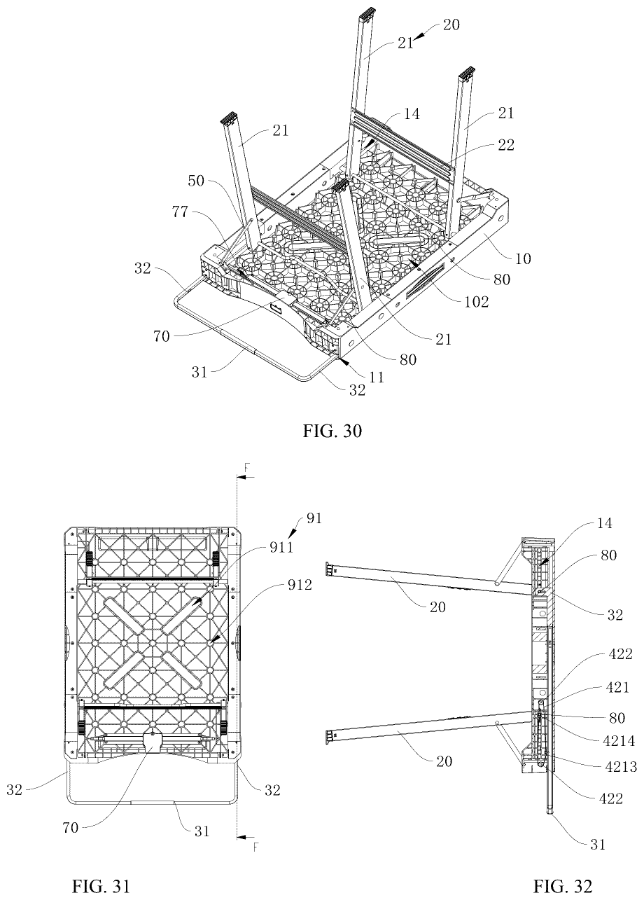

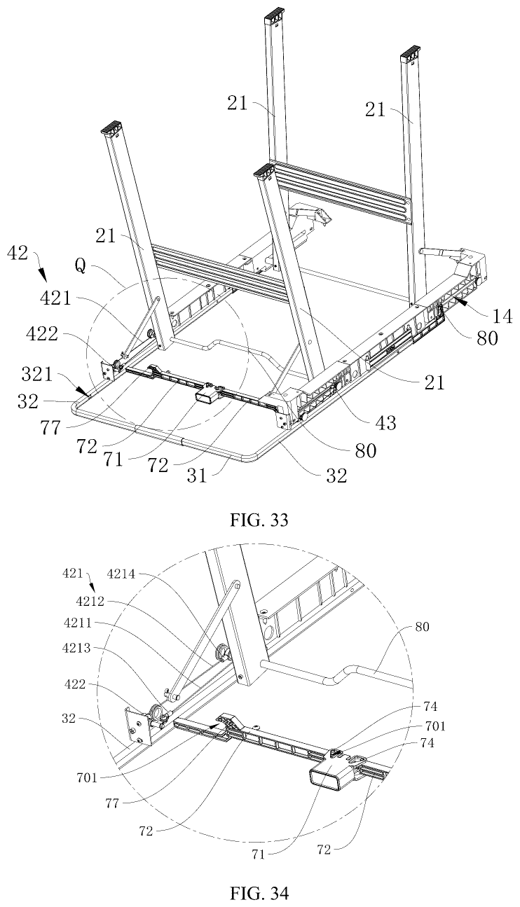

Referring to FIGS. 28 to 34, in the present disclosure, a third embodiment is provided is further provided in the present disclosure, and an inventive concept and most of structures of the workbench 100 of the third embodiment are the same as that of the workbenches 100 of the first embodiment and the second embodiment, except for the following features. Referring to FIGS. 33 and 34, in the third embodiment, a control member 30 and two supporting legs 21 are locked by a second locking structure 70. The second locking structure 70 further includes a lock hook 77. The lock hook 77 is fixed on a second locking member 72. A clamping space 701 is defined between the lock hook 77 and the second locking member 72. When the workbench 100 is switched from a support state to a folded state, one of two supporting structures 20 disposed inside can extend into the clamping space 701, and the lock hook 77 can block one of the two supporting structures 20, which is disposed inside, from separating from the back surface 102 of the bearing platform 10, so that the supporting structures 20 can be remained in the folded state.

Referring to FIG. 33, in an embodiment, in order to facilitate processing, the locking hook 77 is integrated with the second locking member 72.

The workbench 100 provided by the present disclosure can control the two supporting structures 20 to rotate inwards or outwards synchronously via the same control member 30, such that the workbench 100 can be quickly switched to the support state or the folded state, and facilitating effectively improving use convenience and practicability of the workbench 100.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

What is claimed is:

1. A workbench, comprising
a bearing platform, wherein the bearing platform comprises a bearing surface and a back surface away from each other;
two supporting structures, wherein the two supporting structures are rotatably mounted on the back surface, respectively;
a control member, wherein the control member is connected to the bearing platform and capable of moving relative to the bearing platform; and
a connecting assembly, wherein the connecting assembly is configured for connecting the control member to the two supporting structures;
wherein the control member is capable of driving the two supporting structures to rotate via the connecting assembly under the action of an external force, such that the workbench is capable of switching between a folded state or a support state,
when the workbench is in the folded state, both of the two supporting structures are adjacent to the back surface; and when the workbench is in the support state, the two supporting structures are configured to support the bearing platform.

2. The workbench of claim 1, wherein the bearing platform is provided with a first sliding groove, and a part of the control member is disposed in the first sliding groove and capable of sliding in the first sliding groove.

3. The workbench of claim 2, wherein the control member is capable of simultaneously driving the two supporting structures to rotate inwards to the folded state.

4. The workbench of claim 3, further comprising an articulating rod, wherein one end of the articulating rod is pivotally connected to one of the two supporting structures, the other end of the articulating rod is pivotally connected to the bearing platform, the two supporting structures are connected to the bearing platform, the two supporting structures are capable of sliding and rotating relative to the bearing platform.

5. The workbench of claim 4, wherein the connecting assembly comprises a first movable member, a second movable member and a pin axle, the first movable member and the second movable member are disposed in an interleaved manner, the first movable member is pivotally connected to the second movable member via the pin axle, the pin axle is fixed to the bearing platform; both ends of the first movable member are connected to the two supporting structures, respectively, both ends of the second movable member are connected to the two supporting structures, respectively; and
the control member is capable of sliding under the external force, so as to change a cross angle defined between the first movable member and the second movable member, thereby allowing the first movable member and the second movable member to drive the two supporting structures to rotate.

6. The workbench of claim 5, wherein a driving end is defined by an end of the first movable member away from the control member and an end of the second movable member away from the control member, a driven end is defined by an end of the first movable member adjacent to the control member and an end of the second movable member adjacent to the control member; and
the connecting assembly further comprises two first driven members and two second driven members, the two first driven members are slidably disposed on the back surface of the bearing platform, the two first driven members are slidably connected to the driving end of the first movable member and the driving end of the second movable member, respectively, the two first driven members are rotatably connected to one of the two supporting structures away from the control member; and
the two second driven members are slidably disposed on the back surface of the bearing platform, the two second driven members are slidably connected to the driven end of the first movable member and the driven end of the second driven member, respectively, and the two second driven members are rotatably connected to one of the supporting structure adjacent to the control member.

7. The workbench of claim 6, wherein both the driving end of the first movable member and the driving end of the second movable member are provided with a second sliding groove, both the driven end of the first movable member and the driven end of the second movable member are provided with a third sliding groove, the connecting assembly further comprises a driving block and two driven blocks, the driving block protrudes from the control member and is slidably disposed on the second sliding groove; and one driven block of the two driven blocks protrudes from the first driven member and is slidably disposed in the second sliding groove, and the other one driven block of the two driven blocks protrudes from the second driven block and is slidably disposed in the third sliding groove.

8. The workbench of claim 6, further comprising two rotatable rods, the connecting assembly further comprises two supports, one support of the two supports is disposed on the first driven member, and the other one support of the two supports is disposed on the second driven member; one rotatable rod of the two rotatable rods is fixed to one of the two supporting structures and rotatably connected to the first driven member via the two supports; and the other one rotatable rod of the two rotatable rods is fixed to the other one supporting structure of the two supporting structures and rotatably connected to the second driven member via the two supports.

9. The workbench of claim 8, wherein an external surface of one rotatable rod of the two rotatable rods is provided with a ring-shaped restricting groove, the support is provided with a U-shaped groove, the two rotatable rods extends into the U-shaped groove via the restricting groove, the support extends into the restricting groove, and the two rotatable rods are rotatably disposed on the support via the restricting groove.

10. The workbench of claim 4, wherein the bearing platform comprises a first side and a second side away from each other, the two the supporting structures are disposed at the first side of the bearing platform and the second side of the bearing platform, respectively, and the control member is disposed at the first side of the bearing platform;
the connecting assembly comprises a first connecting structure and a second connecting structure, the control member is connected to one supporting structure of the two supporting structures located on the first side of the bearing platform via the first connecting structure, and the control member is connected to the other one supporting structure of the two supporting structures located on the second side of the bearing platform via the second connecting structure; and
when the control member slides along a preset direction under the external force, the first connecting structure is configured for driving an end of one supporting structure of the two supporting structures located on the first side adjacent to the bearing platform to move away from the preset direction, and the second connecting structure is configured for driving an end of one supporting structure of the two supporting structures located on the second side adjacent to the bearing platform to move towards the preset direction.

11. The workbench of claim 10, wherein the first connecting structure comprises a conveyor member and a diverting member, the conveyor member is connected to the diverting member, and the diverting member is configured to change a direction of the conveyor member, the conveyor member is divided into a driving section and a driven section via the diverting member, a direction of movement of the driving section is opposite to a direction of movement of the driven section; and
the control member is connected to the driving section, and the first side of the supporting structure is connected to the driven section.

12. The workbench of claim 1, wherein each of the two supporting structures comprises two supporting legs and at least one cross brace, two ends of the cross brace are connected to the two supporting legs in one supporting structure of two supporting structures; and when the workbench is in the folded state, the two supporting legs in different supporting structures are misaligned.

13. The workbench of claim 12, wherein the two supporting structures comprises a first supporting structure and a second supporting structure, when the workbench is in the folded state, the two supporting legs of the first supporting structure are disposed inside the two supporting legs of the second supporting structure.

14. The workbench of claim 13, further comprising a first locking structure, wherein the first locking structure is disposed on the at least one cross brace of the second supporting structure, the first locking structure elastically abuts against the two supporting legs of the first supporting structure, such that the workbench remain in the folded state.

15. The workbench of claim 14, wherein the first locking structure comprises a first housing, a first trigger member, two first transmission members, two first locking members and two first elastic members; the first housing is fixed on the at least one cross brace of the second supporting structure, the first trigger member, the two first transmission members and the two first locking members are provided on the first housing and capable of moving relative to the first housing, the two first transmission members are connected to two sides of the first trigger member, respectively, each of the two first locking structures is connected to a side of a corresponding first transmission member away from the first trigger member, the two first elastic members act on the two first locking structures, respectively, the two first locking structures are capable of extending out of the first housing and elastically abut against the two supporting legs, respectively; and
the first trigger member is capable of moving under the action of the external force and driving the two first locking members to move via the two first transmission members, such that the two first locking members separate from the two supporting legs of the first supporting structure.

16. The workbench of claim 1, further comprising a second locking structure, wherein the second locking structure is disposed on the bearing platform, the second locking structure is capable of abutting against or separating from the control member, so that the control member is locked in the folded state and/or the support state.

17. The workbench of claim 16, wherein the second locking structure comprises a second trigger member, a second elastic member and a second locking member, the second locking member is connected to the second trigger member, the second elastic member is connected to and elastically act on the second locking member, the second trigger member is capable of moving under the external force and driving the second locking member to move, such that the second trigger member is capable of abutting against or separating from the control member.

18. The workbench of claim 17, wherein when the workbench is in the folded state, the second locking structure is capable of preventing the two supporting structures from separating from the back surface of the bearing platform, such that the two supporting structures are capable of remaining in the folded state.

19. The workbench of claim 18, wherein when the workbench is in the folded state, at least part of one supporting structure of the two supporting structures is capable of pressing the other one supporting structure of the two supporting structures, and the other one supporting structure of the two supporting structures being pressed, is located outside the one supporting structure of the two supporting structures.

20. The workbench of claim 18, wherein the second locking structure further comprises a locking hook, the locking hook is fixed to the second locking member, and an engagement space is defined between the locking hook and the second locking member; and
when the workbench is switched from the support state to the folded state, one of the two supporting structures located inside the other one of the two supporting structures extends into the engagement space, and the locking hook is capable of preventing the one of the two supporting structures from separating from the back surface of the bearing platform, such that the two supporting structures remain in the folded state.
